(19) United States
(12) Patent Application Publication
(10) Pub. No.: US 2024/0333998 A1
(43) Pub. Date: Oct. 3, 2024

(54) INTELLIGENT CONTENT VISIBILITY FILTERING VIA TRANSPARENT SCREEN OVERLAY

(71) Applicant: Adeia Guides Inc., San Jose, CA (US)

(72) Inventor: Charles Dasher, Lawrenceville, GA (US)

(21) Appl. No.: 18/129,449

(22) Filed: Mar. 31, 2023

(51) Int. Cl. H04N 21/431; H04N 21/41; H04N 21/435; H04N 21/442; H04N 21/458; H04N 21/81

(52) U.S. Cl. CPC H04N 21/4312; H04N 21/4122; H04N 21/435; H04N 21/442; H04N 21/458; H04N 21/812

(57) ABSTRACT

Systems and methods are provided herein for personalizing the view of a content item on a primary device. The present disclosure allows individual users to view the primary device and the content item it displays through a secondary device with a second screen which displays the personalized content. A secondary device captures the content displayed on a primary device using a camera connected to the secondary device. The system then determines, using control circuitry, whether any portion of the captured content is undesirable to a user of the secondary device. The secondary device displays an overlay that prevents the user of the secondary device from viewing the undesirable portion of captured content.

### FIELD OF THE DISCLOSURE

The present disclosure is directed to methods and systems for displaying personalized content to a user or group of users. In particular, the present disclosure includes methods and systems for viewing original content on a primary device through a secondary device, where the secondary device generates an overlay over the original content for customizing the content according to user specifications.

### BACKGROUND

While many forms of content are transmitted to a large number of viewers, that content is not always relevant to every viewer. For example, content providers and streaming services often choose which advertisements to display based on factors which may not align with consumers' preferences when taking a multitude of viewers into account. For example, a provider might display an advertisement directed to one age group while the age of viewers of the content span a wide range of ages. The result is that content based on generalized attributes of consumers or based on the known preferences of a single consumer may not be appropriately targeted in situations where more than one consumer is viewing content. Further, there are times within a video where all or a portion of the imagery may be found to be disturbing, inappropriate, or otherwise unpreferred to one or more of the viewers of the content. For example, a TV crime drama that suddenly shows a graphic image of a victim may be offensive to viewers who prefer to avoid graphic images.

One impersonal way to accommodate user-group preferences is by modifying the original content itself. Techniques exist for obscuring, blacking-out, or blurring portions of a video playing on a screen. Commonly, the altering of video to black-out or blur portions requires that the video content itself be altered during production (in the case of, for example, blurring out faces or license plates or even objectionable material). In most cases, questionable content, such as that which may be found objectionable by some, is simply “cut” from the content in order to meet a certain MPAA or TV rating, for instance. In such modifications the content is altered for all viewers, leaving no option to personalize content or censorship.

### SUMMARY

A customizable solution for accommodating individual viewer preferences is desired. The present disclosure differs from existing art in that it does not require altering the original video nor affecting or altering the primary display. Rather, the present techniques enable a customized experience by establishing a relationship (direct or virtual) between a primary display and a secondary display (e.g., between a television and an augmented reality (AR) device). The disclosed techniques may then track locations of the secondary display relative to the primary display in three dimensional space, transmit or receive content metadata describing a projected location of a customizing effect (blur, overlay, or other) or other content overlay on the secondary display such that the effect or content overlay appears as if it were on the primary display. As described herein the term overlay refers to output on the screen of the secondary device that alters the view of the screen of the primary device for the user of the secondary device. In some embodiments an overlay may include supplemental content, or content that is related to a content item such as advertisements, bonus footage, additional information, or links to other content.

Transforming the content via the secondary display can be achieved through tracking the relative distance between the primary and secondary device and determining a corresponding overlay size and shape. Tracking the distance between devices may be done by determining the location of the secondary device based on secondary display tracking. The size of the primary device may be based on information described in metadata and a distance calculation between the secondary display and the primary display. A calculated skew for displaying properly aligned overlays may be based on both the horizontal angles of incidence and well as the vertical angle of incidence. Further, any overlays may be adjusted based on luminance data information as detected by the secondary device.

With the present techniques, users who are viewing the content on the primary display through a secondary display, transparent AR glasses as an example, can choose not to view such content or portions thereof without impacting others' viewing experiences. The secondary display may blur, blackout, or replace portions of the content for only the viewer of the secondary display. An example use case of such personalized viewing experiences includes targeted advertisement placement. In an example of targeted advertisement placement, a display on a primary device might show one advertisement intended for a general audience. When a user views that display through a secondary device, the user's demographic information is determined and a personalized advertisement directed to the demographic of the user is identified. The secondary device displays the personalized advertisement overlaying the general advertisement. The user then instead of seeing the advertisement for the general audience, sees a targeted, personalized advertisement.

In another example, the secondary device may substitute movie previews at movie theaters. For example, if a parent and child see a movie together at the theatre and watch the previews, some previews might be for movies rated “R” which contain scenes not suitable for the child. In that situation, the trailer of the movie might be edited to remove these scenes. However, if the parent views the previews through his or her own personal secondary device, the parent may receive a less censored version of the trailer containing scenes not intended for children.

In another example, the secondary device might darken out the display of a primary device. For example, if a television is on at a restaurant, a patron of the restaurant might view the television with a secondary device. The view through that secondary device might replace the television content with alternate content such as the menu of the restaurant or family pictures, for example. When combined with other technology, audio may also be blocked or substituted allowing for further use cases.

Systems and methods are provided herein for personalizing the view of a content item being presented on a primary device. The present disclosure allows individual users to view the primary device and the content item displayed by the primary device through a secondary device, providing users with a personalized viewing experience. In some embodiments the secondary device determines the boundaries of the screen of the primary device, calculates its size and location and accordingly maps areas of the screen of the primary device to its own screen. Using this mapping, the secondary device may then display transformations, such as alternative content, images replacing specific items in the content, blurring effects, or blackouts, on top of the view of the primary device to create the personalized experience. The secondary device or other components of the system may also continually monitor the primary device to ensure the devices are synchronized and that any transformations remain appropriate. In some embodiments the secondary device includes a transparent screen through which the user views the primary device while the personalized content is an opaque or semi-transparent overlay over the content displayed on the primary device. In one embodiment the secondary device does not include a transparent screen and the personalized content displayed on the secondary device is a recreation of the content on the primary device with adjustments that match the preferences of the user.

In some embodiments the system captures content displayed on a first device using a camera coupled to a second device, identifies a particular portion of the captured content, and causes a display coupled to a second device to generate a content overlay that overlays the identified portion of the captured content.

In some embodiments, boundaries of the captured content or primary device are determined using computer vision. In some embodiments, the first and second devices are paired to one another and communicate via the pair connection. The pairing may be by for example Bluetooth connection or other means.

In some embodiments, the disclosure further comprises monitoring the playback speed of the captured content and adjusting the overlay in response to the playback speed.

In some embodiments, the disclosure further comprises determining angles of incidence between the first device and the second device in the horizontal and vertical directions and adjusting the shape of the overlay in response to the angles of incidence. In some embodiments the system further determines boundaries of a display of the first device using a bounding box displayed on the display of the first device and captured with computer vision software and wherein determining angles of incidence is based on the determined boundaries.

In some embodiments, the disclosure further comprises monitoring metadata related to the captured content and adjusting the overlay in response to the monitored metadata.

In some embodiments of the present disclosure, the overlay displays an image that replaces the particular portion.

In some embodiments of the present disclosure, the overlay displays a blur transformation that obstructs the view of the particular portion.

In some embodiments of the present disclosure, the determining the particular portion is based on a content rating.

In some embodiments of the present disclosure, the particular portion is an advertisement.

According to an aspect, there is provided a computer program that, when executed by control circuitry, causes the control circuitry to perform any of the methods discussed above. For example, there may be provided a non-transitory computer-readable medium, in which is stored computer-readable instructions including instructions to capture content displayed on a first device using a camera connected to a second device, identify a particular portion of the captured content, and cause a display coupled to a second device to generate a content overlay that overlays the identified portion of the captured content.

### BRIEF DESCRIPTION OF THE DRAWINGS

FIG. 1 is a block diagram of a system according to an embodiment of the present disclosure;

FIGS. 2A and 2B are diagrams of displays of devices in an example embodiment of the disclosure;

FIGS. 3A and 3B are diagrams of displays of devices in an example embodiment of the disclosure;

FIGS. 4A and 4A are diagrams of displays of devices in an example embodiment of the disclosure;

FIGS. 5A and 5B are diagrams of displays of devices in an example embodiment of the disclosure;

FIG. 6 is a diagram illustrating viewing angles of the primary device in one embodiment of the disclosure;

FIG. 7 is a diagram illustrating viewing angles of the primary device in one embodiment of the disclosure

FIG. 8A is a diagram illustrating the impact of angles on the view of the primary device and the overlays in some embodiments of the disclosure;

FIG. 8B is a diagram illustrating the impact of angles on the view of the primary device and the overlays in one embodiment of the disclosure;

FIG. 9 is a diagram illustrating views of the screen of the primary device from three different distances in some embodiments of the disclosure;

FIGS. 10A and 10B are diagrams illustrating example bounding boxes in accordance with the present disclosure;

FIG. 11 is a diagram illustrating an example bounding box in accordance with the present disclosure;

FIG. 12A is a diagram illustrating an example manually adjustable bounding box in accordance with the present disclosure;

FIG. 12B is a diagram illustrating an example calibrated bounding box in accordance with the present disclosure;

FIG. 13 is a flow chart illustrating functions of one embodiment of the disclosure;

FIG. 14 is a flow chart illustrating a pairing process in one embodiment of the disclosure;

FIG. 15 is a flow chart illustrating a process performed after pairing in one embodiment of the disclosure;

FIG. 16 is a flow chart illustrating a calibrating process in one embodiment of the disclosure; and

FIG. 17 is a flow chart illustrating functions of one embodiment of the disclosure.

### DETAILED DESCRIPTION

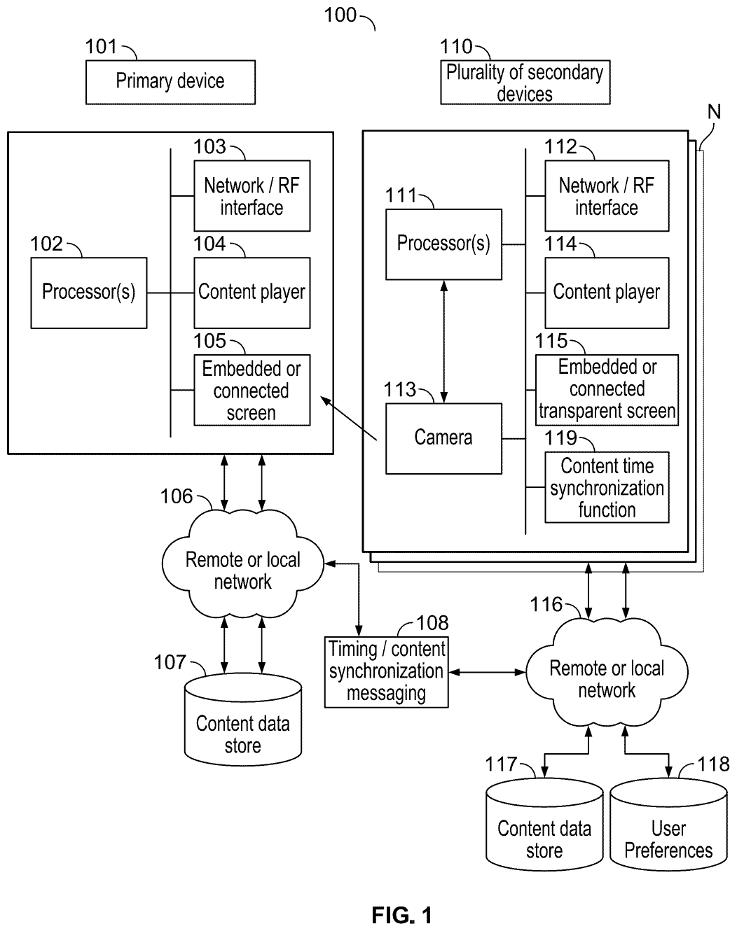

FIG. 1 shows an example system 100 encompassing the present disclosure. The system 100 contains a primary device 101 including a processor 102, network interface 103, content player 104, and embedded or connected display or screen 105. Processor 102 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, hexa-core, or any suitable number of cores) or supercomputer. In some embodiments, processor 102 may be distributed across multiple separate processors or processing units, for example, multiple of the same type of processing units (e.g., two Intel Core i7 processors) or multiple different processors (e.g., an Intel Core i5 processor and an Intel Core i7 processor). Processor 102 may be used to send and receive commands, requests, signals (digital and analog), and other suitable data. Processor 102 in some embodiments is in communication with memory.

Primary device 101 is a display device such as, for example, a TV, a computer display, a projector, movie theater screen or other screen. Primary device 101 displays content to a user using the screen 105 and content player 104. In some embodiments primary device 101 obtains content for display via a remote or local network 106, such as an internet connection, although other sources of content are possible and will depend on the type of device that primary device 101 is, as well as its connectivity capabilities. In some embodiments the network 106 connects primary device 101 to a content data store 107 which contains content items for display. Content items may be for example television shows, movies, videos, advertisements, or any other media intended for viewing.

The system 100 also contains at least one secondary device 110 which includes processor 111, network/RF interface 112, camera 113, content player 114, embedded or connected display or screen 115, and content time synchronization function 119. Processor 111 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, hexa-core, or any suitable number of cores) or supercomputer. In some embodiments, processor 111 may be distributed across multiple separate processors or processing units, for example, multiple of the same type of processing units (e.g., two Intel Core i7 processors) or multiple different processors (e.g., an Intel Core i5 processor and an Intel Core i7 processor). Processor 111 may be used to send and receive commands, requests, signals (digital and analog), and other suitable data. Processor 111 in some embodiments is in communication with memory.

Processor 111 may include video-generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be included. Processor 111 may also include scaler circuitry for upconverting and down converting content into the preferred output format. Processor 111 may be used to receive and to display, to play, or to record content. Processor 111 may also be used to receive guidance data.

Secondary device 110 is a device such as virtual or augmented reality glasses, a headset, or a smartphone capable of displaying augmented reality to a user. Secondary device 110 may be any device having the ability to display images and process information within a 3-dimensional space and to track and adjust to an object's location such as that of the primary display 101. Secondary device 110 preferably includes a transparent screen through which a viewer may view primary device 101 although other devices may in other embodiments suffice as well. In some embodiments, secondary device 110 has the ability to change the opacity of its transparent screen 115 to block portions or the entirety of the area encompassing the screen 105 of the primary device 101. Further, in some embodiments, such as in a scenario in which the portion is an actor who moves position, the blocked portion is movable with respect to the screen 115 of secondary device 110, making the ability to adjust transparency a useful feature. The variation in transparency is convenient for enabling features such as a blur effect, with middle range opacity, while also offering a blocking or replacement effect, with full opacity. Screen 115 may adjust levels of luminesce to show degrees of transparency, in addition to opacity, as well. These effects, referred to as overlays or transformations at times in this disclosure, exist to alter the image of primary device 101 or one or more portions thereof, which the user of secondary device 110 views. The transformations may replace, blur, or block portions of the primary device 101 display 105 to offer an altered view. In some embodiments, the secondary device 110 may further incorporate headphones or speakers for playing audio linked with content. Secondary device 110 offers a personalized view of primary device 101 through the overlays or transformations as the overlays or transformation adjust the view of screen 105 to the preferences or requirements of the user.

Device 110 is connected to remote or local network 116 which may in some embodiments be the same as network 106. Networks 106 and 116 are further connected with content synchronization messaging 108. Content synchronization messaging 108 communicates with primary device 101 and secondary device 110 via networks 106 and 116 to synchronize the display output timing of each device. That is, content synchronization messaging 108 ensures that the timing of an overlay displayed on secondary device 110 aligns with the content displayed on primary device 101 at the time the overlay is displayed. Network 116 is further connected to content data store 117 and user preferences store 118. Content data store includes data related to available content such as playback information and metadata and may inform the system and secondary device 110 about the content and playback on primary device 101. User preferences store 118 includes information about the user such as, for example, demographic information, location, and personal preferences, or any other relevant information. User preferences may in some embodiments be used to determine transformations or displays on screen 115. For example, in one embodiment a user may indicate a preference to view certain sports scores in the bottom right corner of screen 105 during playback of content. In this example, the user preference store 118 may retrieve information regarding a user's preference to view certain sport scores, and upon receiving the information create a transformation that places the sports scores in a position on the screen 115 that, when secondary device 110 is used to view screen 105, aligns to display the sports score in the bottom right corner of the view of screen 105.

The user may in some embodiments view primary device 101 through secondary device 110 by positioning device 110 between a user and primary device 101. Secondary device 110 collects or captures images of screen 105 of primary device 101 using camera 113. Device 110 then processes those images to create transformations, such as overlays, blurs, blackouts, replacement content, or additional content, and displays the images that appear to be on screen 105, with the created transformation, where one exists, on its screen 115 to the user. In this way, the user uses secondary device 110 to view an alternative view of primary device 101 that is personalized for the user. At the same time additional users may view the same content with additional secondary devices and view, using those secondary devices, a personalized experience tailored to them. Using secondary device 115 each user is able to view the primary device 101 as he or she normally would, i.e., in a normal setting such as a theater or living room, while still receiving a personalized experience.

In one embodiment, secondary device 110 may receive the images from a third device, such as a server which is in communication with the secondary device 110 and receives information regarding content displayed on primary device 101.

In some embodiments the environment includes multiple secondary devices 110 through N. In preferred embodiments, each secondary device 110 through N has a unique user such that multiple individuals may watch a single program at the same time together with each user viewing a customized version of the program. For example, a family of four might watch a movie together where each family member views the movie through his or her own secondary device 110. In this example, the parents may view the movie with content unsuitable for children, such as violence, while the children view the movie with only content appropriate for children. In this example, the version the children watch might be the original version of the movie and the parents see an altered version. For example, the secondary devices 110 the parents use may replace the action scenes in the movie with an overlay that displays a more graphic and potentially more violent depiction of that scene. In this scenario, the children do not view the violence, they only view the version appropriate for children. In this example, the entire family is able to watch the movie together without sacrificing preferences, comfort, cohesion, or censoring.

In an embodiment secondary device 110 is paired to primary device 101. Once paired, the devices 101 and 110 may sync to accurately time transformation on the secondary device 110 to line up or coincide with the displayed content on the primary device 101. Pairing is useful in some embodiments because the screen of primary device 101 is constantly changing as the content plays. Syncing the device 101 and 110 helps to ensure that any transformations exist at the correct time to alter the correct frames. This pairing may be done through RF, Bluetooth, WiFi, or other connections. In some embodiments, the secondary device 110 is paired to the video content via computer vision when such devices incorporate a camera and software acting upon a nonce, such a scannable QR code, which has been displayed on the screen 105. In these embodiments, secondary device 110 scans the nonce using camera 113 and process the data retrieved via software. It then may use the retrieved data connected with the nonce to identify and pair with the primary device 101. Upon pairing, the secondary device 110 may request metadata and other information from a source connected with the nonce which may be transmitted to the secondary device 110 from the primary device 101 or other source via Bluetooth or other RF medium or from a content server, edge server or other resource which is reachable by the second device 110.

In some embodiments, after pairing with primary device 101, secondary device 110 captures an image of screen 105 of primary device 101 using camera 113. In some embodiments it next displays an image on its own screen 115, which may be a representation of the image of screen 105 that includes any desired transformations, to a user. For example, in one embodiment, a viewer viewing the content through secondary device 110 might request to view a sports score in a corner of the screen. In this example, secondary device 110 might display the same content as primary device 101 on its own screen but replace the areas representing a corner of the content on the screen 105 with a graphic showing the sports score. In this manner, the transformations can create an image of screen 105 that is personalized specifically for the user's viewing. In an embodiment, the screen 115 of secondary device 110 is transparent and rather than displaying a representation of the image of screen 105 it simply displays the overlay, leaving the remainder of the screen 115 transparent to allow the user to view the portions of screen 105 that are not affected by the overlay. For example, in the example given above where a viewer would like to view the sports score, display 115 might display the sports score on the portion of its screen that aligns with the corner of primary device 101 such that the displayed sports score on 115 covers the corner of the screen 105. In this example the remainder of screen 115 of the secondary device 110 remains transparent to allow the viewer to view the other portions of the content displayed on primary device 101.

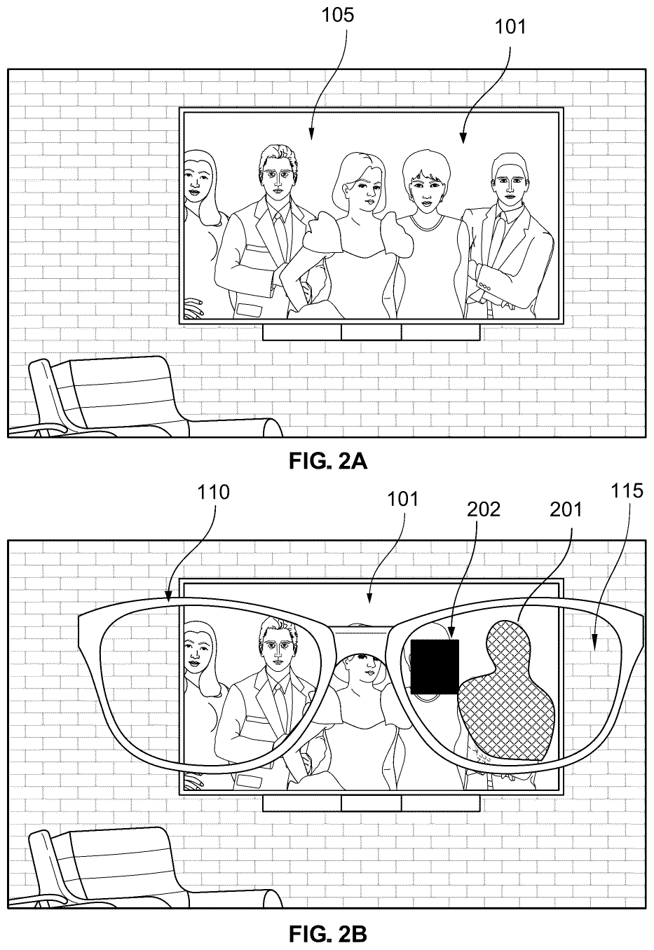

FIGS. 2A and 2B depict an example view using the present disclosure. In FIG. 2A, primary device 101 displays on screen 105 a television show as seen by the user. There are no blurring or black boxes. FIG. 2B depicts the same primary device 101 depicting the same show on screen 105 but as viewed by the user through secondary device 110. As seen in FIG. 2B, a portion 201 of screen 105 is blurred when viewed through secondary device 110. Another portion 202 of screen 105 is blacked out. These blurred and blacked out sections, 201 and 202, represent transformations personalized for the user and are displayed on screen 115. The blur 201 uses the screen 115 at a mid-range transparency and luminescence such that content behind blur transformation 201 is still visible. Alternatively, the black out 202 is opaque, blocking the image behind this portion of screen 115 entirely. In some embodiments opaque overlays may also be used to display alternative content in addition to blocking the content on screen 105. In this embodiment, the user is prevented from viewing the altered parts of the screen 105. As seen from the comparison of FIG. 2A with FIG. 2B, the transformations 201 and 202 of FIG. 2B remove the faces of two people on the display 105, however transformations may remove or replace any content on the display 105. The transformations in some embodiments are determined based on user preferences. In FIG. 2B such a preference might be to avoid certain actors for example. In other embodiments, the transformations might be based on content metadata, parental controls, or other settings.

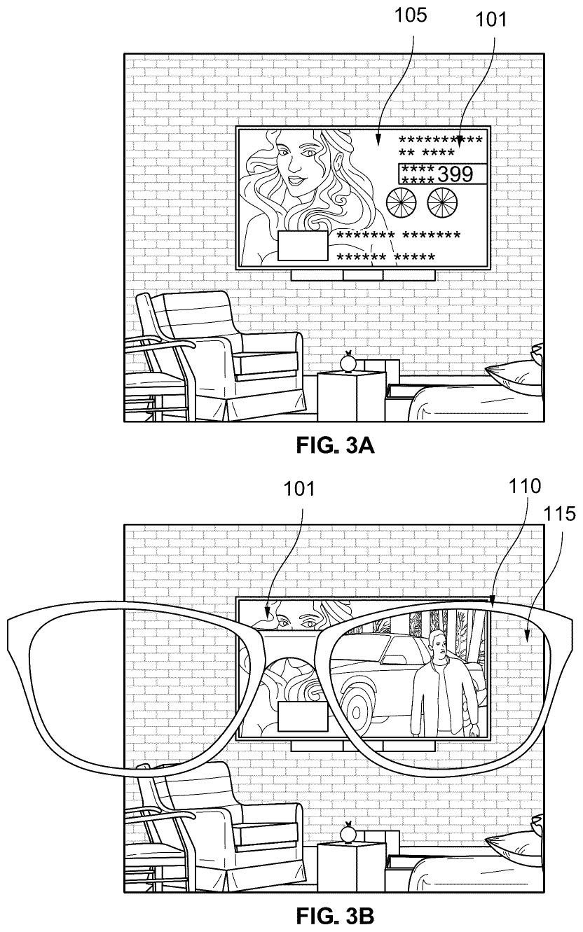

FIGS. 3A and 3B show an example view using the present disclosure in which the primary device 101, the content shown in FIG. 3A, is viewed through secondary device 110 by a user in FIG. 3B. FIG. 3A shows a jewelry advertisement which is targeting viewers who are women. In FIG. 3B secondary device 110 transforms the image of screen 105 to replace an advertisement for jewelry with an advertisement for a car, which does not specifically target women, by displaying the car advertisement on screen 115 where screen 105 is visible. In this embodiment, the portion of screen 115 covering the advertisement on screen 105 is opaque, showing alternative content and preventing view of the original content. In some embodiments the replacement advertisement is tailored to the user such that the replacement advertisement is of particular relevance to the user. For example, the view of FIG. 3B might be informed by a user profile indicating the gender of the viewer. The system receives data indicating that the displayed content on primary device 101 is an advertisement targeting women and in response secondary device 110 replaces the displayed advertisement with a second advertisement targeting its user. In one embodiment a second viewer, a woman fitting the demographic the advertisement intends to target, using a second secondary device 110, views the same screen 105 of primary device 101 with the user of FIG. 3B. In this example, the second viewer may view primary device 101 unchanged through secondary device 110 because user preferences and information for the second viewer indicate the advertisement is relevant to that user.

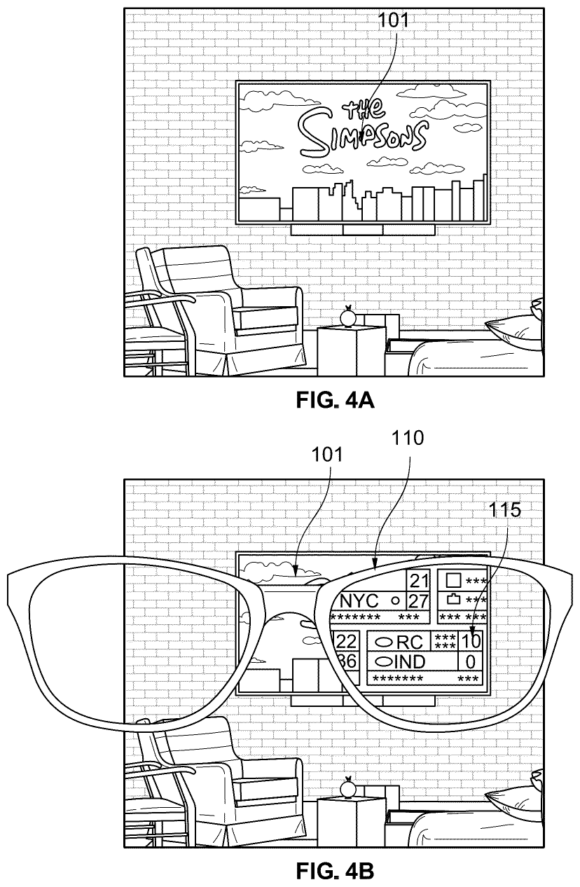

FIGS. 4A and 4B show one embodiment of the present disclosure. depicting primary device 101 displaying a title frame of television show, a cartoon. FIG. 4B shows the same device 101 through secondary device 110. As the Figures show, secondary device 110 transforms the view of the television show from the cartoon to sports scores using an opaque replacement overlay. In this embodiment a user may have indicated a preference to see sports scores during television show introductions or other times that are not important to the story line of the television show. In this embodiment, the transformation displayed on the secondary device 110, the sport scores replacing the television show, reflects a user's preference to view the scores.

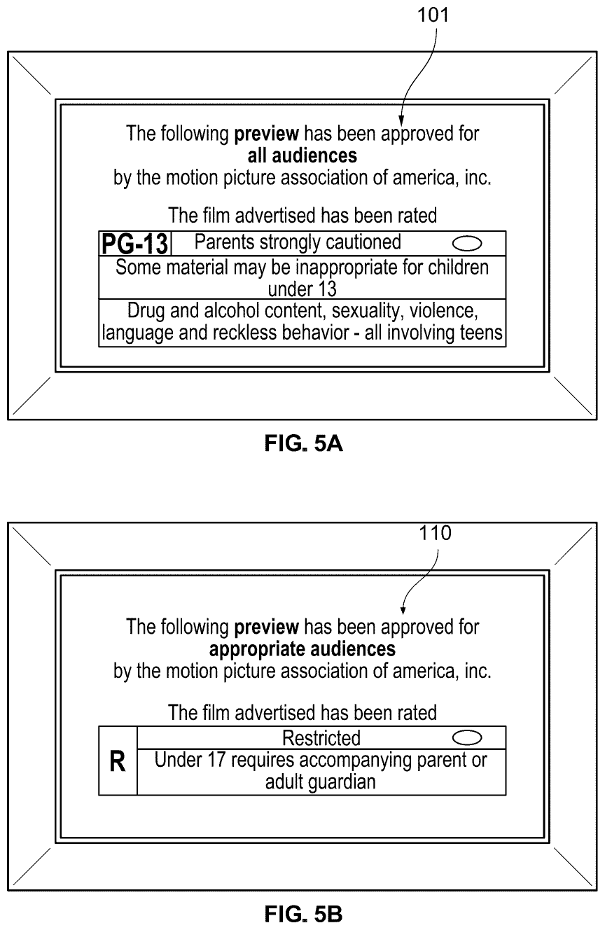

In one embodiment seen in FIGS. 5A and 5B, the disclosure allows a view of a program, movie, or other content to be customized according to a given rating. In FIG. 5A we see the rating screen for a movie trailer displayed on the primary device 101 alone. The trailer is rated PG-13. In FIG. 5B we see the same screen of the primary device 101 through the view of the secondary device 110. Through the view of the secondary device 110, the same trailer is rated R and will include, at times, different content than is shown on primary device 101 by way of opaque overlays with alternate content. Secondary device 110 will display transformations on top of the original content displayed on primary device 101 to alter the original content for the user of secondary device 110. During content creation or, in some instances, in real time, content or portions of video content are identified and classified within a system of rating classifications such as TV MA, PG, R, family friendly, mature, violence, or nudity, etc. This information may be encoded or provided in some embodiments and transferred to the primary device 101 along with the image portion of the content. In one embodiment, the information is delivered within a metadata information stream. In one embodiment the information is embedded visually within the content in such a way as to be unnoticeable to viewers, such as using a QR code or intra-frame images interpretable via computer vision but imperceivable by viewers. These images may also include an embedded time synchronization marker and/or marked content location, such as x,y coordinates based on standard screen sizes or relative to a visually displayed reference point. The present disclosure may in some embodiments receive this rating information in connection with a content item and alter the view of the content item on secondary device 110 accordingly. For example, in one embodiment a user may receive a TV MA television show on primary device 101 but would like to view the television show in a rating appropriate for all audiences. The user may in some embodiments specify this preference to the system and store such in user preferences store 118. This preference might reflect a personal preference, a parental control, or demographic information. The present disclosure may in the example embodiment compare the user preference with the received rating of the content and create transformations on display 115 which update the content item to meet an all audiences rating when viewed through secondary device 110.

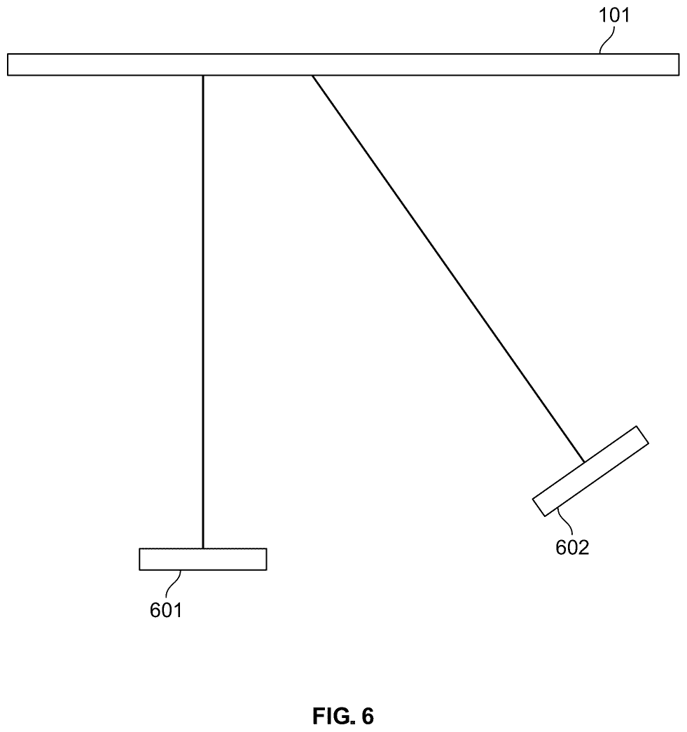

FIGS. 2A, 2B, 3A, 3B, 4A, 4B, 5A, and 5B each illustrate the disclosure from a head-on view, yet a viewer and his or her associated secondary device might at times view the primary device 101 at an angle. FIG. 6 illustrates this scenario. Secondary device 601 is directly in front of primary device 101 while secondary device 602 is turned at an angle toward device 101. As described in more detail below, the angle between devices 601 and 602 will impact the shape of the view of primary device 101 to each user. Transformations may then be shaped according to the shape of the view of primary device 101 to the device 601 or 602 to align with the images displayed on the primary device 101.

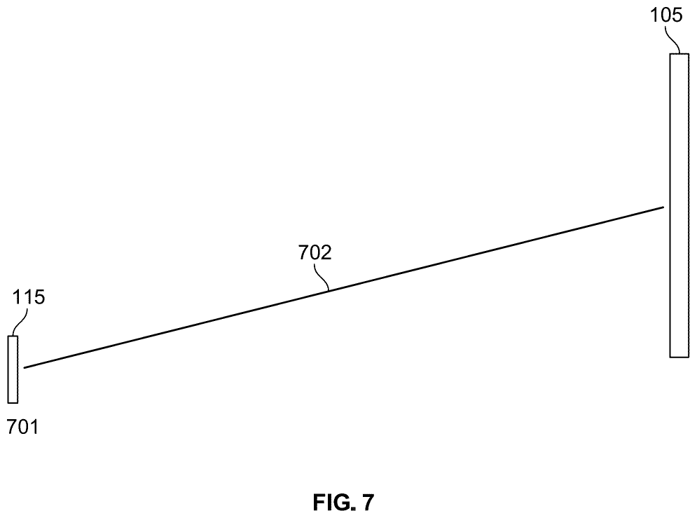

A user might view the screen 105 from above or below the center of screen 105. Both scenarios create a skewed view of both screen 105 and its displayed content. The corresponding pixels, or overlay, in the screen 115 of secondary device 110 that cover the user's view of the screen 105 must also be skewed to line up appropriately to cover the images on screen 105. The impact of a variety of skewed views is illustrated in FIG. 7. In FIG. 7, a secondary device 701, and by extension a user, views the screen 105 from below the center of screen 105 and a line 702 is drawn between the center of screen 105 and the center of screen 115 to show the angle of incidence between the devices.

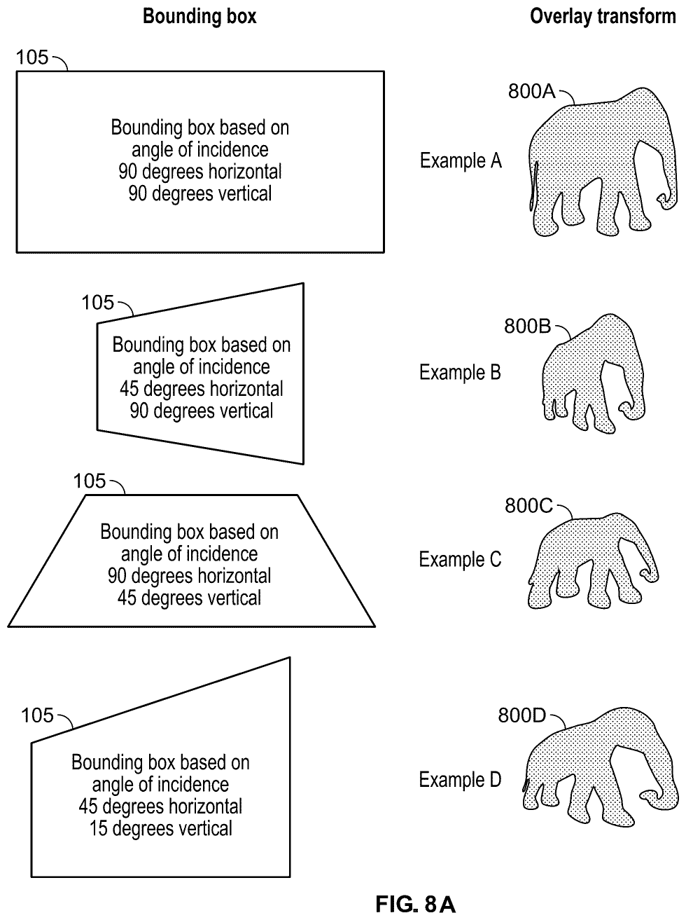

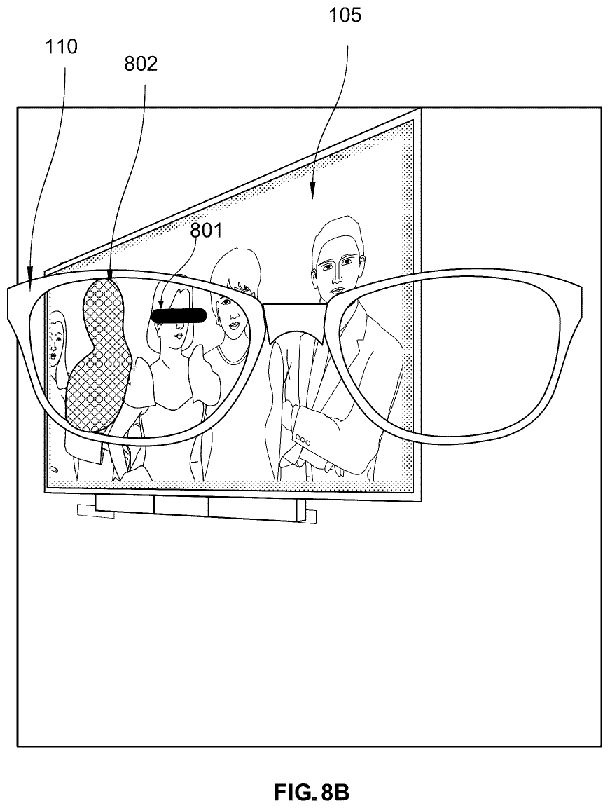

FIG. 8A shows the impact of angles of incidence in both the horizontal and vertical directions on the view of the primary device 101 and the overlays displayed on secondary device 110. Example A shows the view of screen 105 when a secondary device 110 faces the screen 105 head on, that is at a 90-degree horizontal angle and a 90-degree vertical angle. The screen 105 is then seen as a rectangle and corresponding overlay 800A is not askew. In Example B, the secondary device 110 views the screen 105 at a 45-degree horizontal angle and a 90-degree vertical angle. The screen 105 is then viewed such that one side, the side closest to the secondary device 110, is larger than the other, transforming the shape of screen 105 into a trapezoid. The overlay 800B is transformed to similarly be skewed larger on the side closest to the secondary device 110 to match the images on skewed screen 105. Similarly in Example C, where the secondary device 110 views screen 105 at a 90-degree horizontal and a 45-degree vertical, the bottom of the screen, which is closest to the secondary device 110 is larger than the top of the screen and the corresponding overlay 800C is also skewed to match that transformation. Finally, Example D illustrates a situation where both the secondary device 110 views the screen 105 at horizontal and vertical angles. There, the secondary device 110 views the screen 105 at a 45 degree horizontal angle and a 15 degree vertical angle. The overlay 800D is adjusted also in both the horizontal and vertical directions.

FIG. 8B shows the impact of the angle of incidence on an overlay. FIG. 8B includes screen 105 viewed through secondary device 110 at a horizontal angle. The screen 105 is accordingly a trapezoid shape rather than a rectangle. The view through secondary device 110 shows an overlay over two faces shown on screen 105. One overlay, overlay 801 is a black bar. The other overlay, overlay 802, is a blur effect. Both overlays 801 and 802 are skewed according to the angle of incidence between secondary device 110 and screen 105.

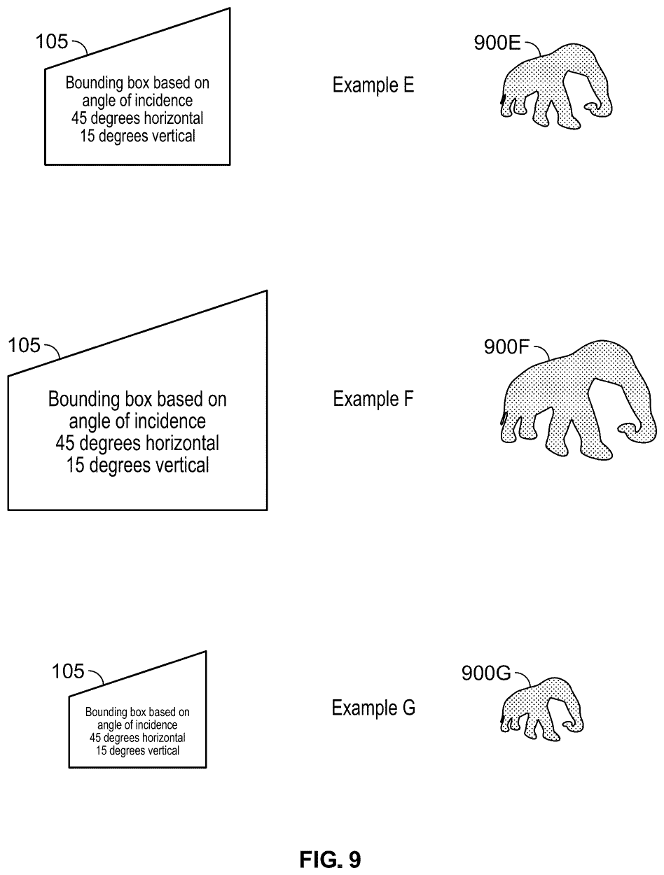

The distance of the secondary device 110 from the screen 105 will also impact the view of screen 105 to the secondary device 110. FIG. 9 shows the view of screen 105 from three different distances. In Example E the secondary device 110 is 10 feet from the screen 105. In Example F the secondary device 110 is 4 feet from the screen 105 and in Example G the secondary device 110 is 15 feet from the screen 105. In each example in FIG. 9 the screen 105 and the corresponding overlay 900 are different sizes according to how close the secondary device 110 is to screen 105. They are the largest in Example F in which the secondary device 110 is the closest and the smallest in Example G where the secondary device 110 is the furthest from the screen 105.

In order to achieve a seamless experience, the secondary device 110 preferably adjusts the shape, size and luminance of the overlay to adapt the overlay according to the viewing angles of the secondary device 110 with respect to the primary device 101. In some embodiments, transformations displayed on screen 115 such as, replacement images or blurring, are based on the location of the object on screen 105, which includes the location of primary device 101, the angle of incidence between the center point of the secondary display(s) 110 the horizontal and vertical direction, and the distance between the primary device 101 display and the secondary device 110. Some embodiments may also consider detected luminance of the primary display 101 for adjusting overlay luminance and/or blur effect on display 115. For example, some embodiments include a display 115 with variable opacity that may adapt to the luminance of primary display 101. In some embodiments, luminance may be detected also using camera 115 and image processing software.

To properly assess these details, such as distance and angles of incidence, the secondary device 110 must in some embodiments detect the bounds of the primary device display 105 to calculate size, distance, and angle of incidence. This may be achieved through computer vision software along with camera(s) 113 incorporated into the second device 110 designed to detect objects such as rectangles via methods used by those skilled in the art.

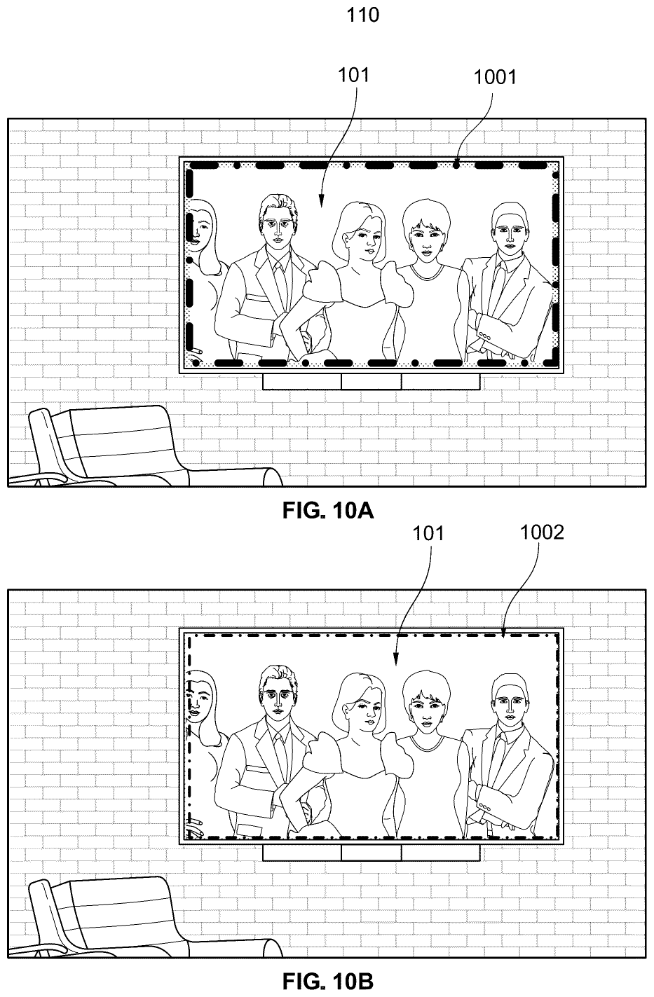

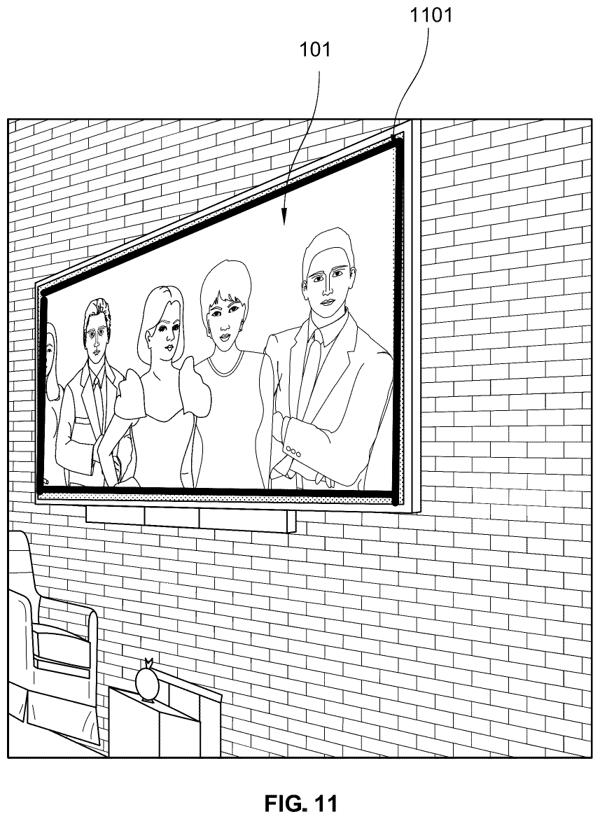

To facilitate the detection of the bounds of the primary display 101, in some embodiments the primary display may incorporate a bounding box, which is a displayed image or pattern on the primary device 101 that another device is able to easily detect. Example bounding boxes 1001,1002 as seen in FIGS. 10A and 10B, both are a patterns around the perimeter of the screen 105 of primary device 101 when viewed without secondary device 110. Another example bounding box is shown in FIG. 11. In FIG. 11, the bounding box 1101 is a solid color and the primary device 101 is viewed from an angle. Accordingly, none of the angles of the four corners of the bounding box 1101 in FIG. 11 are ninety degrees—the edges of the bounding box 1101 are angled, not perpendicular, and are of unequal lengths. The secondary device 110 or other device processes the bounding box will accordingly register some or all of these qualities and use the data to determine the shape or angles of incidence of primary device 101. In some embodiments, the bounding box sits around the perimeter of the device 101 screen 105 and this way, the bounding box is a substitute for the actual bounds of the display 105 and a close approximation of such. In some embodiments the primary display 105 may be triggered to display the bounding box via a menu item, settings change or when a secondary device 110 pairing is detected or requested. In some embodiments it may be displayed continually. It may in some embodiments display an image such as a rectangle around the outer edges of the display 105 which may be of a specific color or pattern that when viewed and processed by the secondary devices(s) 110 and linked computer vision software may improve the detection or tracking of the primary device 101 display 105 by the secondary device 110. The secondary device 110 may in some embodiments scan for the bounding box and when located, register the bounding box as the bounds of the primary device 101 that it will monitor for use in the present disclosure. In some embodiments, once the secondary device 110 has recognized the bounding box of the primary display 105, this rectangle may be altered in shape or size in order to remain on screen 105 while the secondary device 110 is paired. These alterations may be manual or automatic using computer vision software. Further secondary device 110 may include sensors that can be used for more precise distance measurements.

Further, a center point nonce or graphic may be displayed on the center point of the primary device's display 105 allowing for the automatic calculation of the primary device display 105 center point, and by extension overall dimensions, by the secondary device 110 software. Both the nonce and bounding box may be visible to a user or invisible to a user.

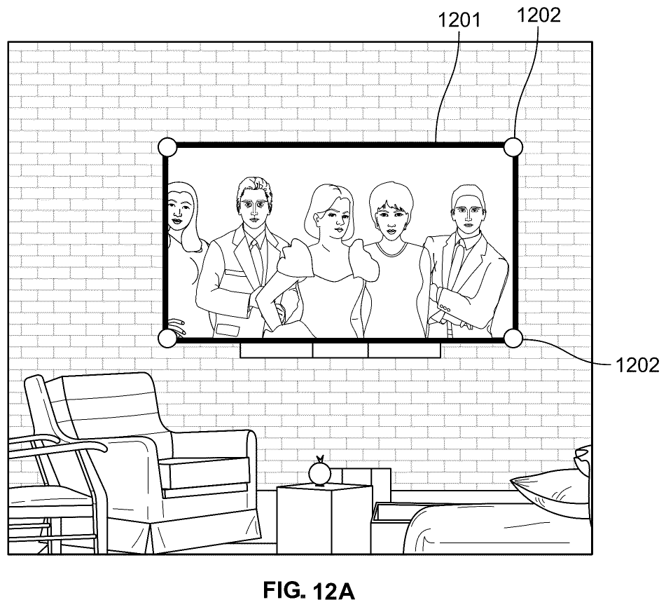

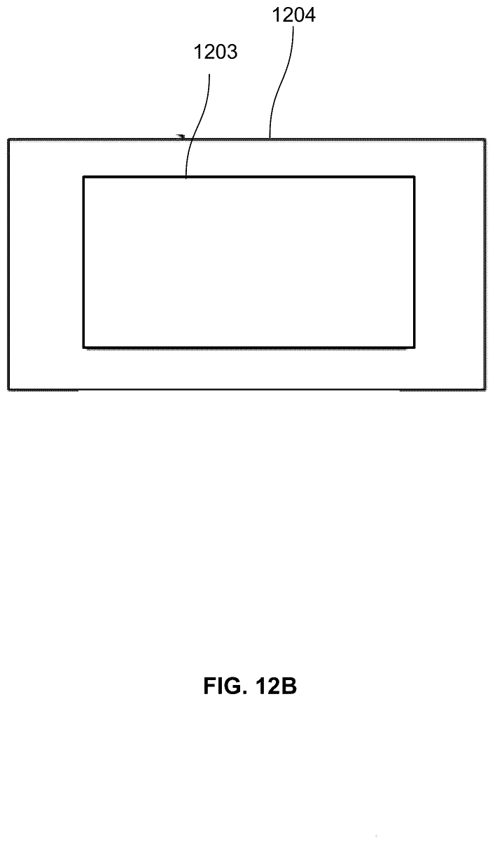

Additionally, the secondary device(s) 110 may be “trained” to detect the bounding box of the primary device display 105 via the use of camera(s) 113 incorporated into the secondary device 110 and corresponding image recognition and tracking software. In some embodiments the software can take input from a plurality of input sources including but not limited to handheld devices, tracking of the orientation of the secondary device(s) display (AR headset tracking), voice control or other method for manipulating objects shown on the secondary display. In some embodiments, the bounding box may be adjusted manually by the user as seen in FIG. 12A. In those embodiments, a rectangle 1201 is displayed on the secondary device display 115 and the user may place, adjust or “crop” the bounding box around the primary device display. For example, as seen in FIG. 12A, the rectangle 1201 includes adjustable points 1202 which a user may move to change the shape and size of the rectangle by matching the points 1202 with the corners of display 105. When the corners are aligned with points 1202, rectangle 1201 will outline the display 105, indicating to secondary device 110 the size and shape of primary device 101. Once a bounding box is placed, the 3D coordinates may be saved for future use.

The bounding box shape and corner angles in comparison to a rectangle, which necessarily has four right angles, establishes an initial skew from which an initial angle of incidence can be calculated. A normal, or perpendicular, location of the secondary device 110 is derived from this information in some embodiments as well.

In some embodiments, the size of the derived normal rectangle is compared to the calculated primary device display screen size 105 to establish an estimated distance between the primary device display 105 and the secondary device display 115. Such an embodiment is shown in FIG. 12B. Derived normal rectangle 1203 seen through the secondary device 110 is shown in that figure. Rectangle 1203 is the bounding box 1201 in a size known based on a previous determination step, metadata, communication with the device, or a nonce. A calibrated bounding box 1204 is then created based on images captured from the primary device 101 by the secondary device 110 and calculated angles of incidence. In FIG. 12B, the calibrated bounding box 1204 is also visible on the secondary device 110. The two boxes, derived normal rectangle 1203 and calibrating bounding box 1204, may then be compared to determine the distance between them. Optionally, in other embodiments, this distance could be calculated using software with input from the secondary device 110 sensors such as but not limited to cameras 113, LiDAR or other sensors capable of scanning an environment, detecting surfaces, and deriving distances. The 3D location of the normalized bounding box may be stored either temporarily or permanently within a datastore to be used during the playback of content or for future use.

In one embodiment, following the establishment of the primary device 101 bounding box and the estimated distance, the secondary device 110 may use its incorporated inertial, motion and/or camera-based sensors to detect its location relative to the projected bounding box. In some embodiments, computer vision software may further assist determining location of the secondary device 110.

The secondary device 110 may in some embodiments calculate an x,y coordinate of the projected bounding box, real time angles of incidence, and distance to be used as a reference point for mapping the x,y coordinates contained within the content metadata to the x,y coordinates of the secondary device display 115 in order to establish an origin point on the secondary device display 115 where an overlay or transformation effect shall be anchored. In these embodiments it may further calculate the skew required for the overlay to align with the display 105 based on the angle of incidence in both the horizontal and vertical direction and the required scaling factor based on the derived or estimated distance from between the primary device 101 and the secondary device 110. In some embodiments the entire display of display 105 is obstructed by an overlay on display 115. In one embodiment only a portion of the display 105 is obstructed by an overlay. In embodiments where only a portion of the display 105 is obstructed, there may be an indication of which portion of display 105 should be obstructed. In some embodiments the indication of which portion of display 105 that should be obstructed is contained in content metadata. In some embodiments such meta might include for example x,y coordinates of a specific portion. In an embodiment, computer vision software is used to recognize a portion, such as an actor or object, that should be obstructed by the overlay. In even further embodiments in which a location, such as a corner, of display 105 is obstructed, the indication of which portion to obstruct may be informed by the bounding box itself.

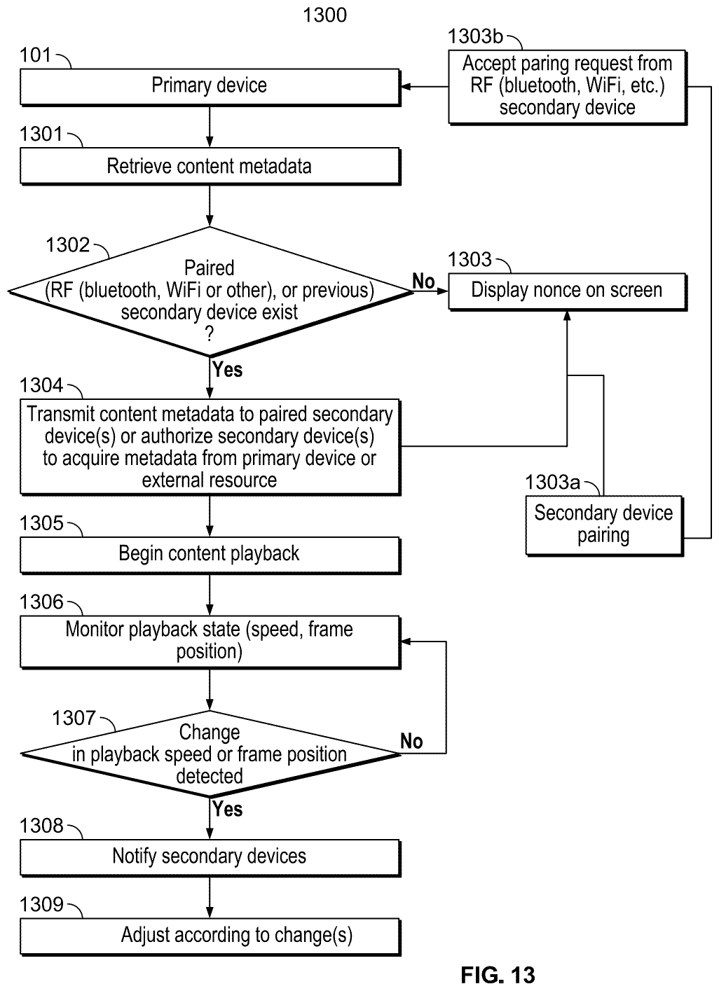

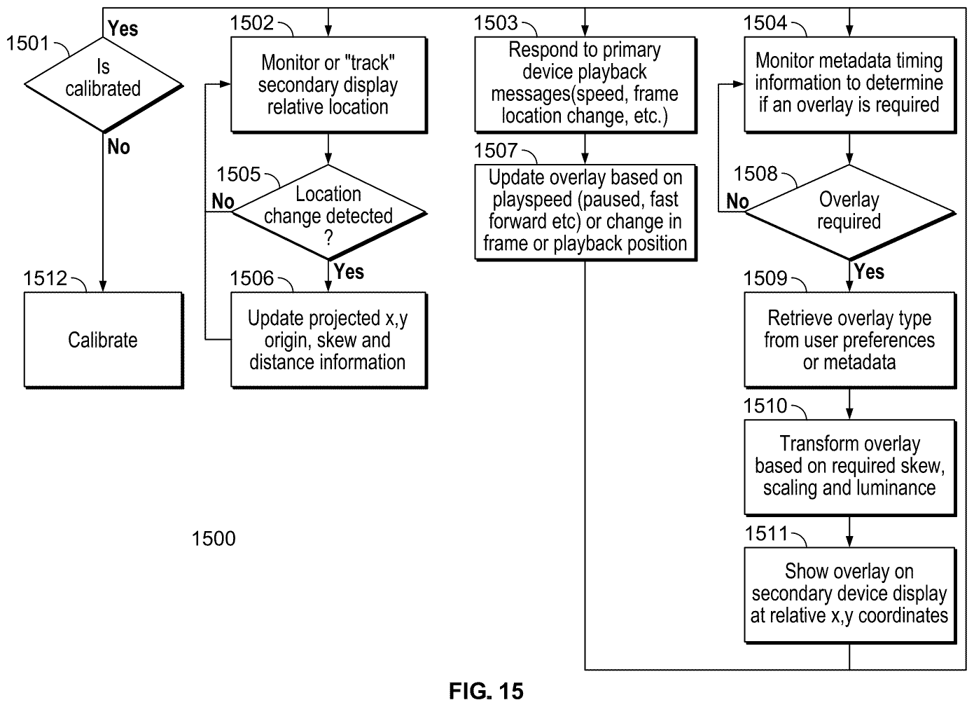

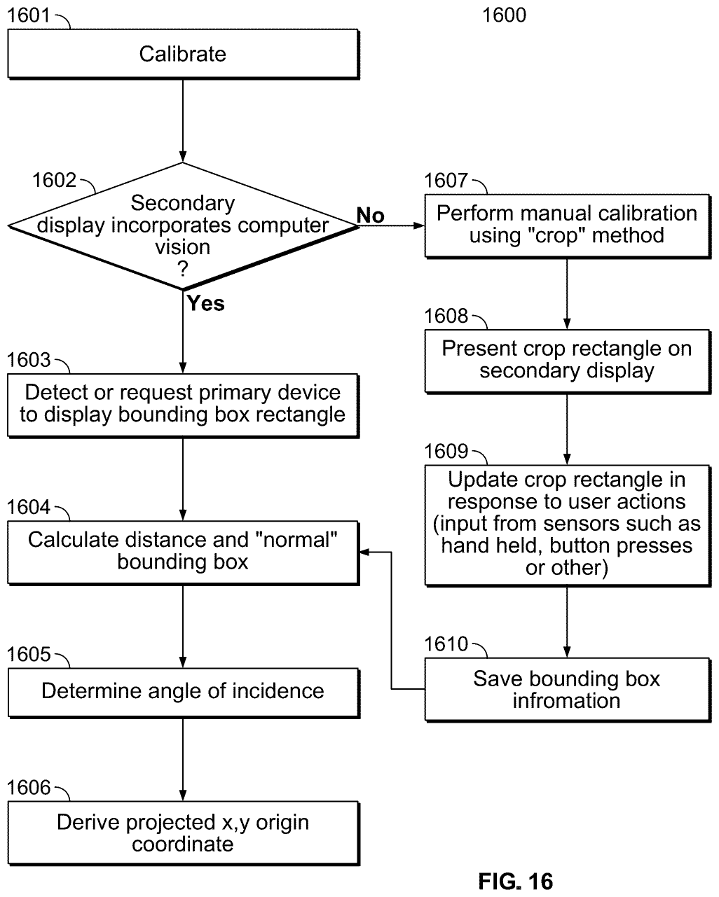

FIG. 13 is a flow chart illustrating a process 1300 performed by the current disclosure in one embodiment. The process 1300 begins at step 1301 where the primary device 101 receives content metadata where content is viewable data such a television show, movie, advertisement or other media. The metadata is information about the content and might include for example a rating, run time, time points for ad breaks, or other information. Next, at step 1302 the system determines if a paired secondary device 110 exists, that is, if a secondary device is paired to device 101. If no secondary device 110 exists, primary device 101 displays a nonce, such as a QR code, on screen 105 at step 1303. The nonce contains pairing information and when scanned will initiate pairing with a secondary device 110. The secondary device pairing is initiated at step 1303a and the pairing request is accepted at step 1303b. The process 1300 then returns to step 1302 to reevaluate the existence of a paired device. If a paired secondary device does exist, the process 1300 moves to step 1304, where the system transmits content metadata to the paired secondary device 110 or authorizes secondary device 110 to acquire metadata from either primary device 101 or an external resource. The source of the metadata will vary between system and depends on factors including, for example, connectivity capabilities and structures of the involved devices. The system then plays the content at step 1305, beginning content playback. At step 1305 the content is displayed on primary device 101 and, in some embodiments, secondary device 110. In other embodiments, due to the transparent nature of the screen 115, it is not necessary to also display the content on the secondary device 110. At step 1306 software on the secondary device 110 monitors the playback speed of the content on primary device 101. At step 1307 the secondary device 110 monitors for a change in playback speed or frame position. If no changes are detected, the process 1300 continues to step 1306 followed by step 1307 to continually monitor playback speed and frame position. If a change in playback speed or frame position are detected, the process 1300 moves to step 1308 in which it notifies secondary device 110. In some embodiments this step involves sending a message to the control center of secondary device 110. Following step 1308, the process moves to step 1309 where the necessary adjustments are made to accommodate the changes, the adjustments including updating the transformation size, shape, location or even presence. For example, in the case where playback speed has changed, step 1309 might include informing content synchronization messaging 108 of the new playback speed and the new playback speed is then reflected on the display of secondary device 110. In an example, if a change in position is detected step 1309 might include recalibrating the devices 101 and 110 to determine angle of incidence between the devices and position of the content. These processes are described in more detail in FIG. 16, which describes calibration, and FIG. 15, which describes monitoring the displayed content on primary device 101.

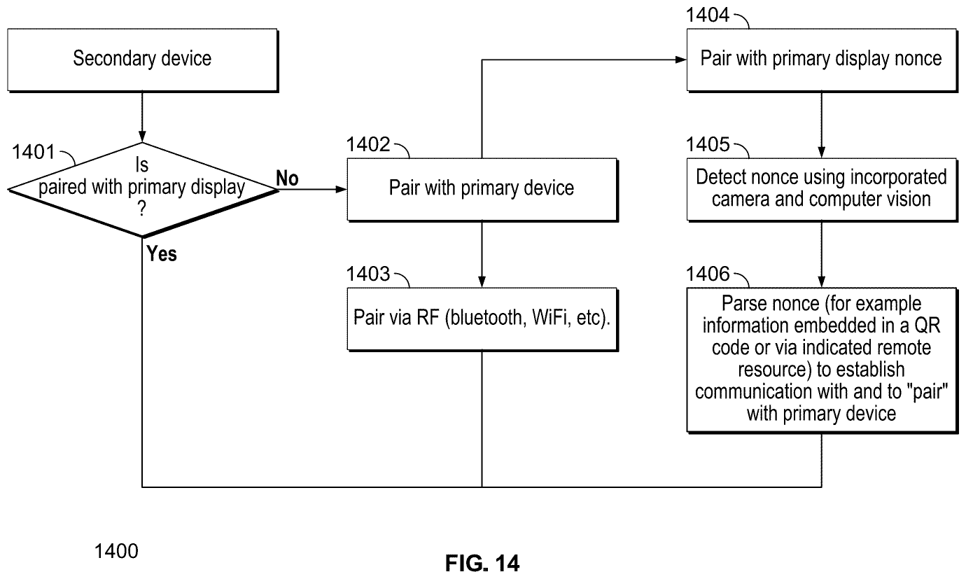

FIG. 14 is a flow chart illustrating a pairing process 1400 performed by the current disclosure in one embodiment. When the secondary device 110 is initiated, it determines whether or not it is paired with a primary device 101 at step 1401. If it is not, process 1400 moves to step 1402 to pair secondary device 110 with a primary device 101. The devices may pair with RF such as Bluetooth, WiFi, etc., or alternative means discussed herein, at step 1403. Process 1400 may however alternatively move to step 1404 to pair via a display nonce. In that scenario, the process 1400 moves to step 1405 to detect the nonce using its camera 113 and internal computer vision software. The process 1400 next parses the nonce at step 1406. This step might include processing information embedded in for example a QR code or indicated remote resource and establish communication and pair with primary device 101.

FIG. 15 is a flow chart illustrating a process 1500 in one embodiment performed by the current disclosure after the devices 101 and 110 have paired. If secondary device 110 determines that it is paired with a primary device 101 upon initiation at step 1401, the process 1500 in some embodiments moves to step 1501 to determine if the device 110 is calibrated, i.e., if it has determined its position and angles relative to primary device 101. If it is not calibrated, the process 1500 continues to step 1512 at which it calibrates secondary device 110. If secondary device 110 is calibrated, for example in a scenario and embodiment in which its orientation has been from past use, process 1500 moves to steps 1502, where it monitors and tracks the relative location of secondary device 110 to primary device 101, 1503, where it responds to the playback message of the primary device 101, such as speed and frame location change, and 1504, where it monitors metadata timing information to determine if an overlay is required. At step 1502, monitoring and tracking relative location, the process 1500 begins an ongoing monitoring process. After it has monitored and tracked secondary device 110 location at step 1502 the process 1500 moves to step 1505, where it determines if it has detected a location change. A location change will imply a change in the size and shape of the screen 105 of primary device 101 and may require an update to the size and shape of any transformations in response. If the process 1500 has determined a change in location, it moves to step 1506, to update projected x and y origin, skew, and distance information. This information will then be processed to correctly adjust the transformations to fit the new size and shape of display 105 on display 115. After 1506, or after step 1505 if a location change is not detected, the process 1500 returns to step 1502 to continue to monitor the location. At step 1503, responding to the playback message of the primary device 101, the process 1500 moves to step 1507 where it updates the overlay based on the playback of the primary device 101. Following step 1507, the process 1500 returns to steps 1502, 1503, and 1504. After step 1504, where it monitors metadata timing information to determine if an overlay is required, the secondary device 110 determines if an overlay is required at step 1508. If it is not, the process 1500 returns to step 1504. If an overlay is required, it retrieves overlay type from user preferences or metadata at step 1509, transforms the overlay based on required skewed scaling and luminance at step 1510, and shows the overlay on the display 115 at the appropriate x,y coordinates at step 1511, after which it returns to steps 1502, 1503, and 1504.

FIG. 16 is a flow chart illustrating a calibrating process 1600 performed by the current disclosure in one embodiment. If secondary device 110 is not calibrated, the calibrating processes 1600 begins with step 1601, calibrating. In some embodiments the display 115 of secondary device 110 incorporates computer vision, meaning secondary device 110 or a device connected with secondary device 110 is equipped with software to process images captured from primary device 101. At step 1602, the process 1600 determines if the display 115 of secondary device 110 incorporates computer vision and if so the process 1600 moves to step 1603 to detect or request primary device 101 to display a bounding box rectangle. Once a bounding box is detected, the secondary device 110 calculates distance and a “normal,” or orientation, of the bounding box at step 1604. At step 1605, the secondary device 110 determines the angle of incidence and at step 1606 derives the projected x,y origin coordinates and then returns to steps 1502, 1503, and 1504 of process 1500. If the secondary device 110 does not incorporate computer vision as determined at step 1602, the device 110 moves to step 1607 in place of 1603 and performs manual calibration using a crop method. At 1608 secondary device 110 presents a crop rectangle on the display 115 and at 1609 updates the crop rectangle in response to user action. At step 1610 the secondary device 110 saves the bounding box information before returning to step 1604.

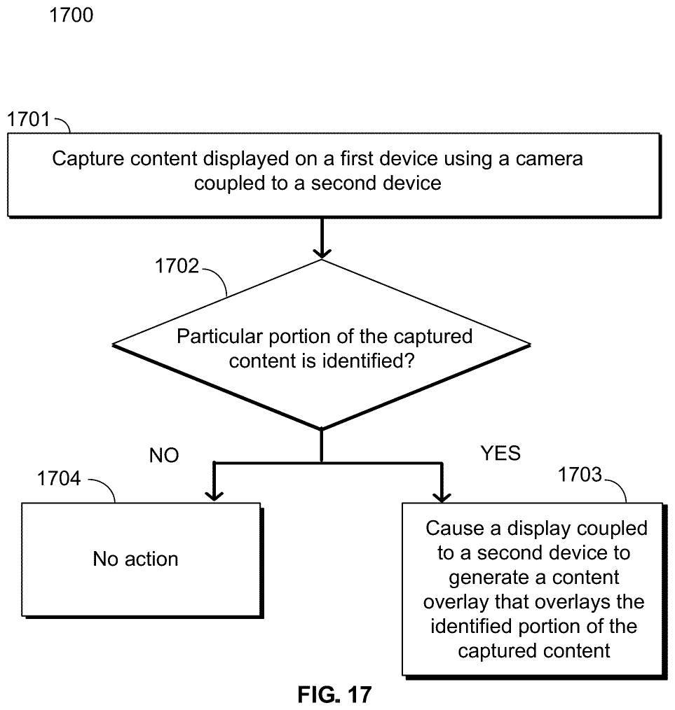

FIG. 17 is a flow chart illustrating the method 1700 of the function of one embodiment of the disclosure. The steps of the embodiments shown in FIG. 17 may be executed by a processor such as processor 111 or similar processing circuitry on another device such as that of primary device 101 or that of a connected server. A primary device 101 displays content. At step 1701 a secondary device 110 captures the content displayed on the primary device 101 using a camera connected 113 to secondary device 110. Next, the method 1700 identifies, at 1702 using control circuitry, metadata, and/or user preferences stored in user preference store 118, a particular portion of the captured content. In some embodiments the control circuitry and identifying exists on software and/or hardware on the secondary device 110. In some embodiments the particular portion is content on the primary device 101 which will be obscured to the user. In some embodiments such portions include specific actors. In another embodiment the particular content is an advertisement. In another embodiment the particular portion is a specific section of primary device 101 such as a corner. Step 1702 identifies these portions based on information received regarding both a user preference and the displayed content. At step 1703, if a particular portion is identified, the secondary device 110 displays on display 115 an overlay that prevents the user from viewing the undesirable portion of captured content. In some embodiments the size, shape, and location of the overlay on the secondary device 110 is determined based on the angles of incidence and distance between the primary device 101 and secondary device 110 as is discussed above. In some embodiments the primary device 101 and the secondary device 110 further communicate with content synchronization messaging 108 to ensure that the overlay on secondary device 110 is timed to properly align with the content on primary device 101. If no particular portion is identified at step 1702, that is if the method 1700 determines that no overlay is necessary based on the user preferences and the displayed content, the method 1700 moves to step 1704 and takes no action.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
capturing content displayed on a first device using a camera coupled to a second device;
identifying a particular portion of the captured content; and
causing a display coupled to a second device to generate a content overlay that overlays the identified portion of the captured content.

2. The method of claim 1 further comprising determining angles of incidence between the first device and the second device in horizontal and vertical directions, and adjusting the shape of the content overlay based on the determined angles of incidence.

3. The method of claim 1, wherein the first and second devices are paired with one another and wherein the first and second devices communicate over the pair connection.

4. The method of claim 1, further comprising monitoring a playback speed of the captured content, and adjusting the content overlay in response to the playback speed.

5. The method of claim 2, further comprising determining boundaries of a display of the first device using a bounding box displayed on the display of the first device and captured with computer vision software and wherein determining angles of incidence is based on the determined boundaries.

6. The method of claim 1, further comprising monitoring metadata related to the captured content, and adjusting the content overlay in response to the monitored metadata.

7. The method of claim 1, wherein the content overlay includes an image that obscures the particular portion of the captured content.

8. The method of claim 1, wherein the content overlay includes a blur transformation that obscures the particular portion of the captured content.

9. The method of claim 1, wherein the identifying a particular portion is based on a content rating.

10. The method of claim 1, wherein the particular portion is an advertisement and wherein the content overlay includes a targeted replacement advertisement.

11. A system comprising:
processing circuitry configured to:
capture content displayed on a first device using a camera connected to a second device;
identify a particular portion of the captured content; and
cause a display coupled to a second device to generate a content overlay that overlays the identified portion of the captured content.

12. The system of claim 11 wherein the processing circuitry is further configured to determine the angles of incidence between the first device and the second device in the horizontal and vertical directions and adjust the shape of the content overlay based on the determined angles of incidence.

13. The system of claim 11 wherein the first and second devices are paired with one another and wherein the first and second devices communicate over the pair connection.

14. The system of claim 11 wherein the processing circuitry is further configured to monitor playback speed of the captured content and adjust the content overlay in response to the playback speed.

15. The system of claim 12 wherein the processing circuitry is further configured to determine boundaries of a display of the first device using a bounding box displayed on the display of the first device and captured with computer vision software and wherein to determine angles of incidence is based on the determined boundaries.

16. The system of claim 11 wherein the processing circuitry is further configured to monitor metadata related to the captured content and adjust the content overlay in response to the monitored metadata.

17. The system of claim 11 wherein the content overlay includes an image that obscures the identified portion of the captured content.

18. The system of claim 11 wherein the content overlay includes a blur transformation that obscures the identified portion of the captured content.

19. The system of claim 11 wherein to identify the identified portion is based on a content rating.

20. The system of claim 11 wherein the particular portion is an advertisement and wherein the content overlay includes a targeted replacement advertisement.

21-50. (canceled)
